(19) United States
(12) Patent Application Publication
(10) Pub. No.: US 2017/0278183 A1
(43) Pub. Date: Sep. 28, 2017

(54) Systems and Methods for Use in Depositing Funds to Deposit Accounts

(71) Applicant: MASTERCARD INTERNATIONAL INCORPORATED, Purchase, NY (US)

(72) Inventor: James Michael Snapp, Butler, PA (US)

(21) Appl. No.: 15/080,696

(22) Filed: Mar. 25, 2016

(51) Int. Cl. G06Q 40/02; G06Q 20/20; G06Q 20/10

(52) U.S. Cl. CPC G06Q 40/02; G06Q 20/1085; G06Q 20/20

(57) ABSTRACT

Systems and methods are provided for depositing funds to a deposit account associated with a consumer. On exemplary method includes initially receiving, at a computing device, a deposit request from a merchant via a payment network and/or an acquirer. The deposit request includes a request to deposit funds to a deposit account associated with the consumer, where the funds to be deposited are received by the merchant, and from the consumer. The method then includes causing, by the computing device, a balance of the deposit account to be increased by an amount associated with the funds, whereby the consumer is able to deposit the funds to the deposit account by presenting the funds to the merchant without interacting with a banking institution and/or automated teller machine (ATM) associated with the deposit debit account.

### FIELD

The present disclosure generally relates to systems and methods for depositing funds (e.g., cash, other monetary value, etc.), to deposit accounts and, in particular, for depositing the funds to the deposit accounts at merchant locations, rather than at traditional banking institutions and/or automated teller machines (ATMs).

### BACKGROUND

This section provides background information related to the present disclosure which is not necessarily prior art.

Consumers often use payment accounts to purchase various different products (e.g., good and services, etc.). The payment accounts may operate on credit, i.e., are credit accounts, or they may be based on funds deposited to the payment accounts, i.e., are deposit accounts or prepaid accounts. Deposit accounts may include checking accounts or other types of banking accounts, to which funds are deposited by individuals to whom the accounts are issued, or by others, at particular banking institutions and/or automated teller machines (ATMs) associated with the banking institutions. The funds may then be selectively withdrawn by the individuals when desired (e.g., to purchase products from merchants, etc.). Conversely, prepaid accounts are typically used solely as purchase accounts, to which funds are deposited often by interactions with issuers of the particular prepaid accounts or at merchant locations that support acceptance of cash which is then applied to the prepaid accounts using an available “reload” network.

Regardless of type, when a payment account is used to fund a purchase transaction at a merchant, the merchant causes an authorization request to be transmitted to the issuer of the payment account, generally via an acquirer associated with the merchant and a payment network. In turn, the issuer responds with an authorization reply, which indicates to the merchant that the transaction is either approved or declined. If the transaction is approved, funds are then exchanged by and between the issuer and the merchant (or the acquirer associated with the merchant), and potentially others, during clearing and settlement of the transaction. Alternatively, if the transaction is declined, the merchant can stop the transaction or request alternate payment.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in depositing funds to deposit accounts, based on deposit transactions at merchants;

FIG. 2 is a block diagram of a computing device that may be used in the exemplary system of FIG. 1; and

FIG. 3 is an exemplary method, which may be implemented in the system of FIG. 1, for depositing funds to a deposit account based on a deposit transaction at a merchant.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment accounts are often employed by consumers to fund purchases for products (e.g., goods and/or services, etc.) at merchants. Following such purchases, the consumers associated with the payment accounts typically cause funds to be paid to the issuers of the payment accounts to either repay credit expended in purchase transactions for the products (in connection with credit payment accounts) or to load (or deposit) funds to the payment accounts for use in future purchase transactions (in connection with deposit payment accounts). With respect to deposit payment accounts, the consumers are directed to banking institutions associated with the deposit accounts to deposit funds for subsequent use, or to automated teller machines (ATMs) associated with the banking institutions or other entities substantially acting on behalf of, or in cooperation with, the banking institutions to deposit the funds.

In connection with deposit payment accounts, the systems and methods herein uniquely allow consumers to deposit funds (specifically cash and funds with cash value) to desired deposit accounts (e.g., to primary payment accounts associated with payment devices, etc.) at locations associated with merchants (e.g., by making payments to the merchants, which the merchants then transfer to the consumers' deposit accounts; etc.), without separately seeking out and interacting with particular banking institutions associated with the deposit accounts (i.e., issuers of the deposit accounts). In particular, the systems and methods herein leverage the merchants' access to payment networks (through which purchase transactions for products at the merchants are conventionally processed) to permit the merchants to receive funds from the consumers and deposit the funds to the deposit accounts identified by the consumers (i.e., route the funds to the issuers of the deposit accounts without the consumers needing to seek out physical locations of the issues). As such, a consumer may present cash (and potentially other acceptable monetary value) to a merchant and, in turn, the merchant can cause a deposit request to be transmitted through a payment network to an issuer of the identified deposit account (e.g., the primary payment account associated with a payment device presented to the merchant along with cash to be deposited, etc.). The request then causes the monetary value to be deposited in (broadly, appended to) the deposit account. In this manner, numerous additional locations may be available to the consumer to deposit cash or other monetary value into a desired deposit account provided by the issuer. In addition, the deposited funds are generally immediately available in the identified deposit account for subsequent use.

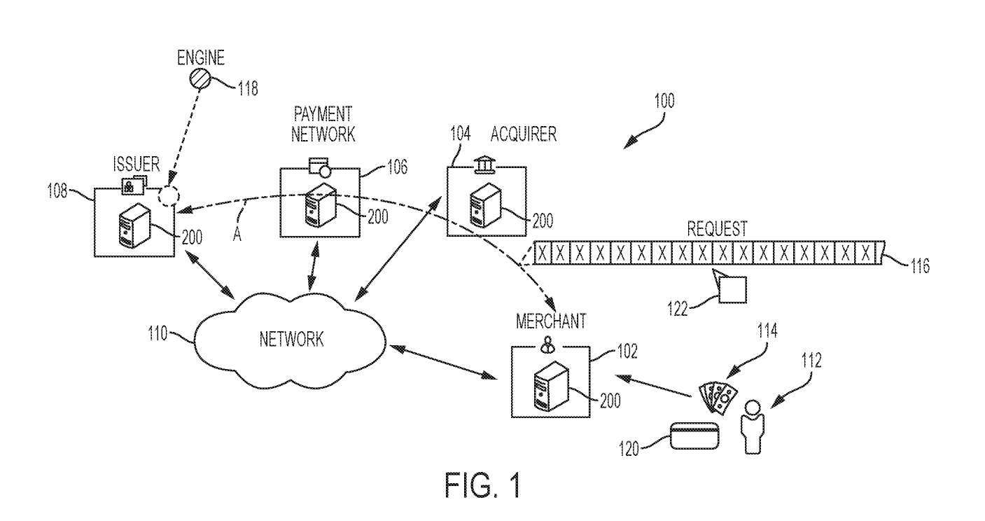

FIG. 1 illustrates an exemplary system 100, in which the one or more aspects of the present disclosure may be implemented. Although the system 100 is presented in one arrangement, other embodiments may include systems arranged otherwise depending, for example, on the manner of processing purchase transactions to payment accounts, etc.

The system 100 generally includes a merchant 102, an acquirer 104, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network 110 may include multiple different networks, such as a private payment transaction network made accessible by the payment network 106 to the acquirer 104 and the issuer 108 and, separately, the public Internet, which is accessible as desired to the merchant 102, the acquirer 104, the issuer 108, and a consumer 112.

The merchant 102 is generally associated with products (e.g., goods and/or services, etc.) for purchase by one or more consumers (e.g., the consumer 112, etc.). Specifically, the merchant 102 is involved in the sale of products to consumers, including the consumer 112. With that said, as used herein, the merchant 102 is not a banking institution. That is, the merchant's primary functions are those associated with facilitating transactions for products, and not those associated with conventional banking operations, including, for example, accepting deposits, issuing payment accounts, making loans or otherwise extending credit, etc. While only one merchant 102 is shown in FIG. 1, it should be appreciated that multiple merchants may be included in the system 100 or as part of other systems in other embodiments. Similarly, while only one acquirer 104, one payment network 106, one issuer 108, and one consumer 112 are illustrated, it should be appreciated that any number of these entities (and their associated components) may be included in the system 100, or may be included as a part of systems in other embodiments, consistent with the present disclosure.

In a conventional purchase transaction to a payment account (e.g., a credit account, a deposit account, etc.), for example, involving the merchant 102 and the consumer 112, the consumer 112 presents a payment device (associated with the payment account) to the merchant 102 in connection with purchasing desired products. The payment device may include, for example, a payment card, a payment token, a payment tag, a pass, a communication device configured by an electronic wallet (or e-wallet) application, etc. In turn, the merchant 102 reads or otherwise captures payment credentials for the payment account (e.g., via a point-of-sale (POS) terminal, etc.) and generates an authorization request (e.g., as an ISO 8583 message, etc.), which generally includes transaction data associated with the purchase transaction (as described more below). As shown in FIG. 1 by path A, the merchant 102 initially communicates the authorization request to the acquirer 104, who in turn communicates the authorization request to the issuer 108 through the payment network 106 (e.g., MasterCard®, VISA®, Discover®, American Express®, etc.) to determine whether the payment account is in good standing and whether there is sufficient credit or funds to complete the transaction. In embodiments where the payment credential includes a payment token, the payment network 106 may also translate the payment token to an account number for the consumer's payment account (and append it to the authorization request), for subsequent use in identifying the payment account (e.g., by the issuer 108, etc.). If the issuer 108 accepts the transaction, a reply authorizing the transaction is conventionally provided back to the acquirer 104 and the merchant 102 (e.g., as an ISO 8583 message, etc.), thereby permitting the merchant 102 to complete the transaction (with the payment network 106 potentially translating the account number back to the payment token, in the embodiments where the payment credential includes the payment token). The transaction is later cleared and/or settled by and between the merchant 102 and the acquirer 104 (via an agreement between the merchant 102 and the acquirer 104) and by and between the acquirer 104 and the issuer 108 (via an agreement between the acquirer 104 and the issuer 108), via further communications (e.g., along path A in the system 100, etc.). However, if the issuer 108 declines the transaction, a reply declining the transaction is conventionally provided back to the merchant 102 along path A, thereby permitting the merchant 102 to stop the transaction.

Transaction data is generated, collected, and stored as part of the above conventional interactions among the merchant 102, the acquirer 104, the payment network 106, the issuer 108, and the consumer 112. The transaction data represents at least a plurality of purchase transactions, for example, authorized transactions, cleared transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104 and/or the issuer 108 may store the transaction data, or part thereof, in a data structure, or transaction data may be transmitted between parts of system 100, as used or needed (e.g., for clearing, etc.). With that said, transaction data may include, for example, primary account numbers (PANs), amounts of the transactions, merchant IDs, merchant category codes (MCCs), dates/times of the transactions, products purchased and related descriptions or identifiers, etc. It should be appreciated that more or less information related to transactions, as part of either authorization, clearing, and/or settling, may be included in transaction data and stored within the system 100, at the merchant 102, the acquirer 104, the payment network 106, and/or the issuer 108.

In various exemplary embodiments, consumers (e.g., the consumer 112, etc.) involved in the different transactions herein are prompted to agree to legal terms associated with their payment accounts (including their deposit accounts), for example, during enrollment in their accounts, etc. In so doing, the consumers may voluntarily agree, for example, to allow merchants, issuers, payment networks, etc., to use data collected during enrollment and/or collected in connection with processing purchase transactions to the payment accounts, subsequently, for one or more of the different purposes described herein.

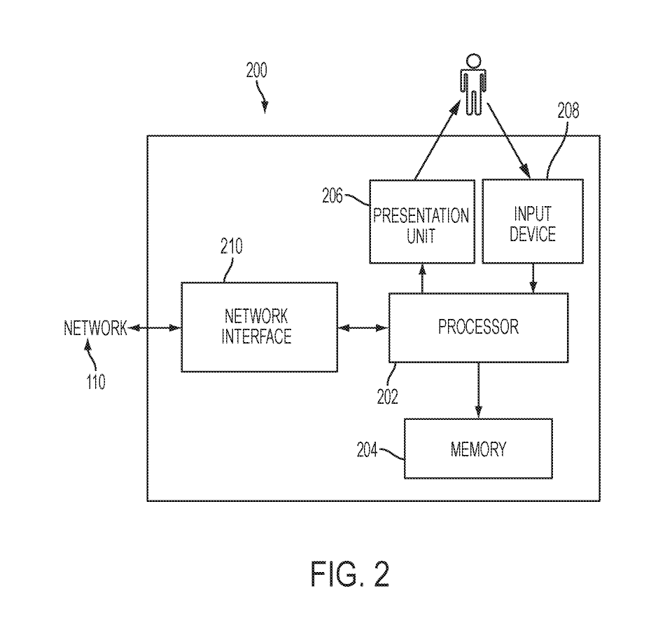

FIG. 2 illustrates an exemplary computing device 200 that can be used in the system 100. The computing device 200 may include, for example, one or more servers, workstations, personal computers, laptops, tablets, smartphones, PDAs, point-of-sale devices, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices. In the system 100 of FIG. 1, each of the merchant 102, the acquirer 104, the payment network 106, and the issuer 108 are illustrated as including, and/or being implemented in, a computing device 200, coupled to (and in communication with) the network 110.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable storage media. The memory 204 may be configured to store, without limitation, transaction data, authorization records, clearing records and/or batch files, deposit records, payment token conversions (e.g., as associated with token vaults, etc.), and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the operations or processes described herein.

In the exemplary embodiment, the computing device 200 includes a presentation unit 206 that is coupled to (and in communication with) the processor 202 (however, it should be appreciated that the computing device 200 could include output devices other than the presentation unit 206, etc.). The presentation unit 206 outputs information (e.g., deposit account details, etc.), either visually or audibly to a user of the computing device 200, for example, the consumer 112 in the system 100 (e.g., at the computing device 200 at the merchant 102 in connection with a deposit transaction, at a computing device (not shown) associated with the consumer 112, etc.), etc. Various interfaces (e.g., as defined by internet-based applications, webpages, short message service (SMS) messages, emails, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, selections of deposit options, verification options, etc. The input device 208 is coupled to (and in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network 110. Further, in some exemplary embodiments, the computing device 200 includes the processor 202 and one or more network interfaces incorporated into or with the processor 202.

Referring again to FIG. 1, in the system 100, the consumer 112 is in possession of funds 114 (broadly, monetary value), which may be in the form of cash, or other paper (or other medium) with specific value (e.g., a check to be cashed, a winning lottery ticket, etc.). In addition, the consumer 112 is associated with a deposit account (a primary account provided by the issuer 108, for example, and associated with an access device 120 such as a payment device, an ATM card, a debit card, a token, etc.), into which the consumer 112 may desire to deposit the funds 114 (e.g., for subsequent use in purchase transactions as described above, etc.), for example, as a “payment-to” transaction. Uniquely in the system 100, rather than finding a location of the issuer 108 or an ATM associated with the issuer 108 in order to deposit the funds 114, the consumer 112 instead goes to the merchant 102 in the system 100 (or to another participating/enrolled merchant). In so doing, and as will be described, the merchant 102 receives the funds 114 from the consumer 112 (and generally transfers the funds to an account associated with the merchant 102), and then causes a deposit for a value of the funds 114 (or at least a portion of the value of the funds) to be made to the consumer's deposit account (potentially less any fees required for such service, for example, processing fees, convenience fees, administrative fees, etc.), via a request 116 (e.g., a “payment-to” request, a deposit request, etc.).

In one example transaction, at the merchant 102, the consumer 112 initially indicates that a deposit is desired and then identifies the funds 114, to the merchant 102, to be deposited. In addition, the consumer 112 presents the access device 120 to the merchant 102 associated with the consumer's deposit account. In turn, the merchant 102 reads a primary account number (PAN) from the access device 120 (e.g., via a POS terminal, etc.) and generates the request 116 for an amount of the funds 114. The request 116 may then be transmitted by the merchant 102 (e.g., via the POS terminal, etc. (i.e., originating at the POST terminal, etc.)) to the issuer 108, along path A in the system 100 (e.g., via the acquirer 104 and the payment network 106, etc.). Any fees associated with the transaction, in this example, are collected by the merchant 102 and are in addition to the amount of the funds 114 being accepted as a deposit/payment to the consumer's account. In some implementations, the consumer 112 provides payment for the fees when giving the funds 114 to the merchant 102, while in other implementations, the merchant 102 may provide payment for the fees (for example, as a way to encourage the consumer 112 to patronize the merchant 102, etc.). Further, in some implementations, any fees associated with the deposit service may be deducted from, or parsed from, a value of the funds 114 being deposited.

The request 116, as generated in the system 100 and as associated with deposit of the value of the funds 114 to the consumer's deposit account, may include an ISO 8583 message (e.g., a 0100 message (associated with an authorization request and utilizing “transaction code 28” to indicate a “payment-to” transaction) or a 0200 message (associated with a financial request from the acquirer 104) consistent with an ISO 8583 standard financial transaction card originated message, etc.) communicated along path A from the merchant 102 to the acquirer 104, to the payment network 106, and to the issuer 108. The ISO 8583 message may include various transaction data relating to the underlying “payment-to” transaction including, for example, the PAN from the consumer's access device 120 (used by the issuer 108 to associate the “payment-to” transaction with the consumer's deposit account) and, potentially, an amount associated with the funds 114. In addition, transaction code 28 within the ISO message may be used to indicate that the transaction is a payment to the consumer's deposit account (i.e., as a primary account associated with the consumer's access device 120) (broadly, a data entry, such as data entry 122 in FIG. 1, associated with request 116).

Generally in the system 100, for issuers (including the issuer 108) that choose to participate in this service, the payment network 106 may use a specific service code designation for the issuers' bank identification numbers (BINs) (or a portion of the BIN ranges) to indicate to merchants in the system 100 (including merchant 102) that the devices issued under those BINs are eligible to participate in this functionality (such as access device 120). Devices within BINs that are not identified by such service code designation(s) will be unable to be used for merchant deposits as described herein.

In addition in the system 100, when the access device 120 is associated with a payment token, the merchant 102 may initially read or otherwise capture the payment token from the access device 120 and include the token in the request 116. Then, as the request 116 is transmitted to the issuer 108 along path A in the system 100, the payment network 106 (or, in some embodiments, a third party token vault associated with the payment network 106) translates the payment token to the PAN for the consumer's account and appends the PAN to the request 116 (e.g., in an ISO 8583 message associated with the request 116 (e.g., in “transaction code 28,” etc.), in a similar manner as described above; etc.). As such, the issuer 108, upon receiving the request 116, can use the PAN to identify the consumer's account (e.g., to associate a “payment-to” transaction with the consumer's account as described herein, etc.).

With further reference to FIG. 1, the system 100 also includes a deposit engine 118 configured (e.g., by computer executable instructions, etc.) to perform one or more of the operations described herein. The deposit engine may include a computing device (or may be implemented in a computing device) consistent with computing device 200. The deposit engine 118 is illustrated as a stand-alone part of the system 100. However, as indicated by the dashed line in FIG. 1, the deposit engine 118 may alternatively be associated with, or incorporated with or in, the issuer 108 (e.g., as an issuer computing device, etc.). Further, in various other embodiments, it should be appreciated that the deposit engine 118 may be associated with, or incorporated with, still other parts of the system 100, for example, the acquirer 104, the payment network 106, the issuer 108, etc.

In particular in the system 100, the deposit engine 118 is configured to identify the request 116 (and thus the associated “payment-to” transaction), when transmitted along path A in the system 100, and, when identified, facilitate a deposit of the funds 114 into the consumer's deposit account (i.e., into the deposit account identified from transaction data in the request 116). In so doing, the deposit engine 118 distinguishes the request 116 from other requests in the system 100 (e.g., from authorization requests, clearing requests, etc.). The deposit engine 118 then pushes the funds identified in the request 116 (from transaction data in the request 116), from an account associated with the merchant 102, to the appropriate deposit account associated with the consumer 102, less any fees.

In an example, the issuer's authorization system (or third-party issuer processor acting on their behalf) will recognize the above example transaction involving the access device 120 as a “payment-to” transaction, and deliver that information to the issuer 108 of the consumer's access device 120. A stored record at the issuer 108, or at the issuer processor location, will identify the consumer's primary deposit account associated with the access device 120 (via the PAN) to which the deposited funds 114 should be credited. Then, in the daily settlement process, the payment network 106 will receive settlement funds for all deposit transactions (including the deposit transaction involving the consumer 112) from the acquirer processor (e.g., from the merchant's account, etc.) and deliver the settlement funds for the deposit transactions to the issuer processor (similar, but generally opposite, to the funds movement process for conventional purchase transactions). In some embodiments, the issuer 108 may impose limits on how much can be deposited per transaction, per day, etc., and/or impose velocity limits regarding a total number of deposits allowed per day, per week, etc.

For example, when the request 116 includes an ISO 8583 message, the deposit engine 118 is configured to identify the PAN for the consumer's deposit account from the ISO 8583 message and, based on whether or not the PAN is within a particular range of PANs (or, alternatively, within a particular range of BINs associated with the PANs), identify (or not) the ISO 8583 message as involving a “payment-to” transaction. When the PAN for the consumer's deposit account is within the predefined range of PANs (or BINs), the deposit engine 118 is configured to cause the funds 114 to be transferred from an account associated with the merchant 102 to the consumer's deposit account. However, when the PAN is outside the predefined range of PANs (or BINs), the deposit engine 118 is configured to decline to cause the funds 114 to be transferred from the merchant's account to the consumer's deposit.

In addition, or alternatively, when the request 116 includes the ISO 8583 message, the ISO 8583 message may include an indicator of the “payment-to” transaction (e.g., a deposit indicator, etc.) included in one or more data entries of the ISO 8583 message (indicating the deposit of the funds 114 to the consumer's deposit account) (e.g., transaction code 28, etc.). Here, the deposit engine 118 is configured to then determine whether or not the deposit indicator is present in the ISO 8583 message and, when present, identify the ISO 8583 message as involving the “payment-to” transaction.

In any case, once the deposit engine 118 identifies the request 116 as including a “payment-to” (or deposit) transaction and causes (or facilitates) deposit of the funds 114 into the consumer's deposit account, it is configured to update an account balance for the deposit account and notify (or causes such notification to) the merchant 102 and/or consumer 112 that the deposit has been completed. Through the “payment-to” transaction, the deposited funds are generally immediately available in the consumer's deposit account for subsequent use. Upon approval of the transaction by the issuer 108, and transmission of the approval message to the merchant 102, a receipt will be generated by the merchant 102 describing the amount of the deposit (or load, or payment) transaction. At that time, the funds are available to the access device 120 to be used for purchases, withdrawals at ATMs, transfers, on-line payments, or through any other channels available to the access device 120.

In addition, generally any fees associated with the “payment-to” transaction are collected by the merchant 102 (in addition to, or from, the amount of the funds 114 being accepted as a deposit/payment/load to the consumer's access device 120) or, in some embodiments, are funded by the merchant 102 (in order to drive consumer traffic to the merchant 102, for example). The amount of any such fees is indicated in the message from the merchant 102 to the payment network 106. Typically, there are no fees (other than normal transaction processing fees) assessed to the issuer 108 or the merchant 102 with respect to these “payment-to” transactions. When such fees are involved, the deposit engine 118 is configured to direct the fees to appropriate accounts, once collected (e.g., from an account associated with the merchant 102 to an appropriate account, if other than the merchant's account; etc.).

In the system 100, “payment-to” transactions generally exclude any transactions to payment accounts that may be reversed. For example, “payment-to” transactions do not include refund transactions that may take place when consumers use payment accounts to purchase products, and subsequently return the products to merchants (for refunds). Rather, as used herein, “payment-to” transactions are original deposits of monetary value to deposit accounts, processed as “payment-to” transactions.

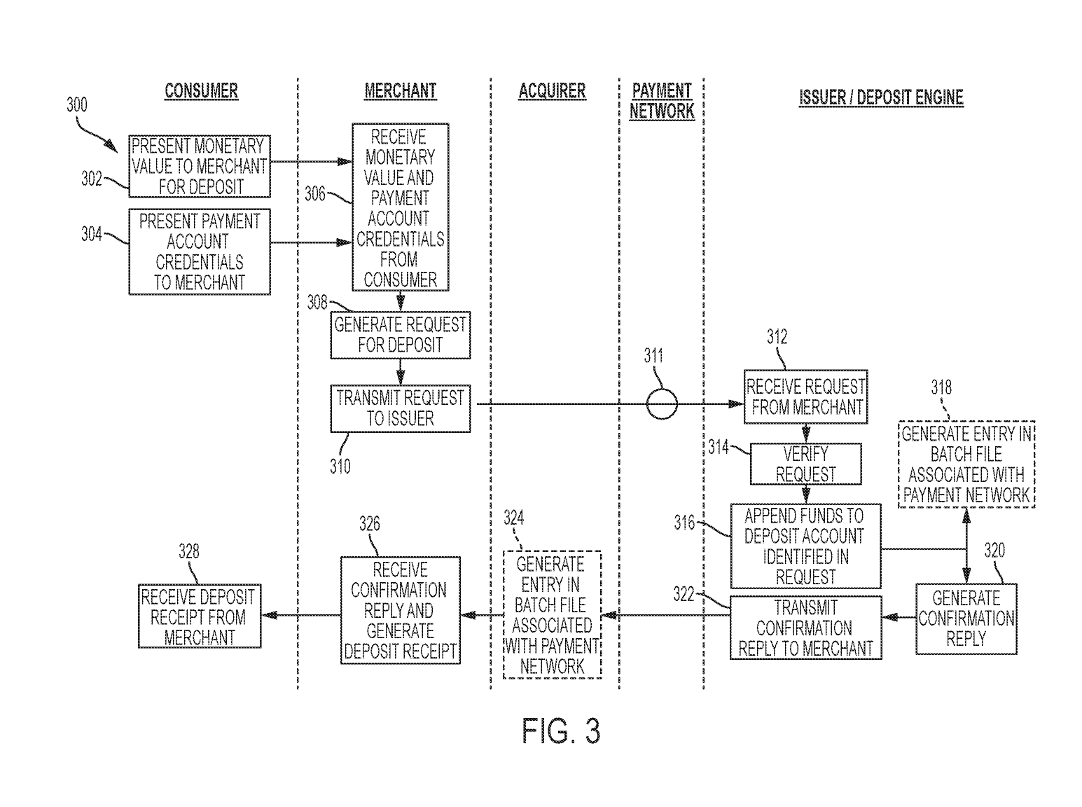

FIG. 3 illustrates an exemplary method 300 for use in depositing funds to a deposit account, in connection with a deposit (or “payment-to”) transaction by the consumer 112 at the merchant 102, for example. The exemplary method 300 is described as implemented in the deposit engine 118 of the system 100, particularly at the issuer 108, and in connection with interactions between the consumer 112, the merchant 102, the acquirer 104, the payment network 106, and the issuer 108. However, it should be understood that the method 300 is not limited to this description, as the method 300 may be implemented in other parts (or combination of parts) of the system 100 (e.g., in the deposit engine 118 as a stand-alone entity, in the deposit engine 118 as part of (or particularly at) the payment network 106, in other parts of the system, etc.). As such, the methods herein are not limited to the exemplary system 100, or for that matter the exemplary computing device 200, and likewise, the systems and the computing devices herein are not limited to the exemplary method 300.

Generally in the method 300, the consumer 112 initially enrolls his/her deposit account with the deposit engine 118, so that deposits can be made at merchants (e.g., at merchant 102, etc.) to the deposit account. In so doing, the consumer 112 may create a profile and define parameters for such deposits. Similarly, the merchant 102 initially enrolls with the deposit engine 118, so that the merchant 102 can facilitate deposits to deposit accounts. The merchant 102 may also create a profile and define parameters for such deposits (e.g., fees and/or fee schedules for such deposits, etc.). In general, the decision to permit deposits at merchant locations using debit access devices (e.g., access device 120, etc.) is made by the issuers of those devices. Issuers will, through the network (or networks) in which the devices are issued, pass an indicator (specific service code associated with a BIN, or range of PANs within a BIN) to acquirer processors. These indicators/codes will enable acquirers (and their merchants) to determine whether or not specific cards are or are not eligible to participate in this service. Merchants which offer this service will make that election with their acquirer and the networks, and agree to a network specified fee structure as part of their enrollment. Merchants may or may not elect to assess additional fees for these transactions, and may or may not elect to charge such fees to the consumers desiring to use the service.

Following enrollment, when the consumer 112 desires to deposit the funds 114 to his/her deposit account, the consumer 112 interacts with the merchant 102 (for example, as opposed to the issuer 108 associated with the consumer's deposit account). In particular, to initiate a deposit transaction, the consumer 112 presents the funds 114 to the merchant 102, at 302, and instructs the merchant 102 to deposit the funds 114 into the consumer's deposit account. The consumer 112 also provides deposit account credentials to the merchant 102 (e.g., a PAN, a token, etc.), at 304, for the particular deposit account into which the funds 114 are to be deposited (e.g., the primary account associated with the consumers access device 120, etc.). In turn, the merchant 102 receives the funds 114 from the consumer 112 and the deposit account credentials, at 306.

For example, the merchant 102 may include a point-of-sale (POS) device typically used to process purchase transactions for products at the merchant 102. In the method 300, however, the merchant 102 may also use the POS device in connection with the deposit transaction for the consumer 112. In so doing, the merchant 102 may activate a deposit module at the POS device (e.g., via a particular selection or input at the POS device, etc.), and then enter an amount for the funds 114 to be deposited. The consumer 112 may then present a deposit card (or other suitable payment device) (broadly, access device 120), associated with the consumer's deposit account, to the POS device in order to provide a PAN (or other credential) for the deposit account to the merchant 102 (along with any required authentication associated with the consumer's deposit account (e.g., a personal identification number (PIN), etc.)). In this manner, the merchant identifies the amount of the funds 114 to be deposited and the PAN (access device number) associated with the deposit account into which the funds 114 are to be deposited. In various embodiments, the POS device may also display fees associated with the deposit transaction (if any), and require approval and/or authorization from the consumer to proceed with the transaction.

Next in the method 300, the merchant 102 (e.g., via the POS device, etc.) generates the request 116, at 308, for the deposit transaction (e.g., as a “payment-to” request, etc.). The request 116 generally identifies the amount of the funds 114 to be deposited and the PAN for the particular deposit account into which the funds 114 are to be deposited. At 310, the merchant 102 (e.g., via the POS device, etc.) then transmits the request 116 to the issuer 108 (associated with the consumer's payment account), via the acquirer 104 and the payment network 106 (e.g., along path A in the system 100, etc.). And, the issuer 108 receives the request 116, at 312.

For example, the deposit request 116 may include an ISO 8583 message (e.g., as conventionally generated in connection with purchase transactions at merchants, etc.), such as a 0100 message (as conventionally associated with an authorization request) or a 0200 message (as conventionally associated with a financial request from the acquirer 104) consistent with the ISO 8583 standard. The ISO 8583 message may include various transaction data for the “payment-to” transaction including, for example, the PAN for the consumer's deposit account and the amount associated with the funds 114 to be deposited in the deposit account. In addition, the message may include a “payment-to” indicator at one or more data entries of the message, to thereby identify the message as involving a deposit transaction. As described above, transaction code 28 within the ISO message may be used to identify the transaction as a “payment-to” transaction. Discretionary data within the ISO message may also be used to identify any consumer-paid fee information to the issuer 108.

When the deposit account credentials provided to the merchant 102, at 304, include a token, the merchant 102 includes the token in the request 116 (when generated at 308), in place of the PAN for the deposit account. Then, as the request 116 is transmitted to the issuer 108 (at 310), the payment network 106 (or, in some embodiments, a third party token associated with the payment network 106) identifies that the request 116 includes the token and translates the token, at 311, to the PAN for the consumer's deposit account and appends the PAN to the request 116 (e.g., in an ISO 8583 message associated with the request 116, in a similar manner to that described above; etc.). Once appended, the request 116 continues to the issuer 108. And, as described above, the issuer 108 receives the request 116, at 312 (with the PAN for the consumer's deposit account appended thereto).

With continued reference to FIG. 3, upon receipt of the request 116 at the issuer 108, the deposit engine 118 evaluates (or reviews) the request 116, at 314, to determine (or confirm) if it involves a deposit transaction. For example, the deposit engine 118 may identify the PAN for the consumer's deposit account from the request 116 (e.g., from the ISO 8583 message associated therewith, etc.) and compare it to different predefined ranges of PANs (or, alternatively, to different predefined ranges of BINs) specifically associated with enrolled deposit accounts. When the PAN falls within one of the different predefined ranges, the deposit engine 118 identifies the request 116 as involving a deposit transaction (or “payment-to” transaction). Alternatively (or additionally), the request 116 may include an indicator that the transaction involves a deposit transaction (e.g., the ISO 8583 message associated with the request 116 may include a deposit indicator at one or more data entries in the ISO 8583 message, etc.). Then, upon receipt of the request 116 at the issuer 108, the deposit engine 118 evaluates (or reviews) the request 116 for the indicator. When the indicator is identified (or found), the deposit engine 118 identifies the request 116 as involving a deposit transaction.

In various embodiments, in connection with determining if the request 116 involves a deposit transaction, the deposit engine 118 may also determine if the consumer's deposit account is enrolled to receive deposits from the merchant 102 and, similarly, if the merchant 102 is enrolled to make deposits to the consumer's deposit account.

When the deposit engine 118 determines that the request 116 does not involve a deposit transaction, the deposit engine 118 may decline the request 116 (and terminate any further processing). Or, the deposit engine 118 may identify the request 116 as an authorization request (e.g., in connection with a conventional purchase transaction, etc.) or other request, and instruct the issuer 108 to process the authorization request in a conventional manner (e.g., as described above in the system 100 in connection with the purchase transaction between the consumer 112 and the merchant 102, etc.).

However, when the deposit engine 118 determines that the request 116 involves a deposit transaction (e.g., the PAN for the consumer's deposit account falls within a particular range of PANs, the deposit request 116 includes a particular deposit indicator, etc.), at 314, the deposit engine 118 deposits (broadly, appends) the funds 114 (or at least a portion of the funds) into the consumer's deposit account, at 316. In particular, the deposit engine 118 identifies the appropriate amount associated with the funds 114 and deposits the amount to the consumer's deposit account (as described above in connection with system 100). In so doing, the deposit engine 118 may directly deposit the funds to the consumer's deposit account, for example, from an account associated with the merchant 102. Or, the deposit engine 118 may issue an instruction, for example, to the issuer 108, to the acquirer 104, etc., to cause the funds to be deposited to the consumer's deposit account from an account associated with the merchant 102. Consequently, the deposit engine 118 also causes a balance of the deposit account to be increased by the amount deposited (whereby the consumer 112 is able to deposit the funds 114 without interacting with a particular location associated with the issuer 108 (that provided the deposit account to the consumer 112), such as a banking institution or ATM).

The amount of the funds 114 deposited into the consumer's deposit account will generally include the actual amount associated with the funds 114. Any fees associated with the deposit transaction will typically be collected by the merchant 102 on the front end, and are in addition to the amount of the funds 114 accepted for deposit. For example, if the fee is $2.50, and a deposit of $100 is requested, the merchant 102 will collect $102.50 from the consumer 112, and upon successful completion of the “payment-to” transaction, receive a receipt evidencing a $100 increase in the consumer's deposit account balance.

The “payment-to” (or deposit) transactions herein are intended to provide near real-time access to the deposited funds (e.g., within micro-seconds of the transaction, within a few seconds of the transaction, within a few minutes of the transaction, within a time interval generally accepted in the art for providing real-time access to funds following a deposit, etc.). As such, typically there is no batch functionality as it relates to the transaction processing during the authorization. In general, the transactions will use the PIN networks (e.g., as provided by Maestro, Pulse, Interlink, etc.) for verification/authentication, and the clearing item will be presented on-line, as well (i.e., 0200/0210 functionality in the ISO message, rather than the 0100/0200 associated with a signature transaction.) However, if these signature transactions are applied, then a batch file will be created as part of the settlement/clearing process. Additionally, issuer processors may create a batch posting (or input) file for their issuers to use in applying the financial transactions as part of their end-of-day process. The on-line advice/memo post (which provides the instant funds availability) will be replaced, in the nightly cycle, with a posted item (of the same amount.)

With that said, and with further reference to FIG. 3, in connection with depositing the funds 114 into the consumer's deposit account, the deposit engine 118 may (as indicated by the dotted lines in FIG. 3) generate an entry in a batch file associated with the payment network 106 (i.e., to be submitted to the payment network 106 in association with clearing and/or settlement) for the deposit transaction, at 318 (depending on whether PIN transactions or signature transactions are used, for example). When generated, the entry provides, from a standpoint of the issuer 108, a record of where the funds 114 and any associated fees are coming from and where they are going. The batch file, and particularly the generated entry, can then subsequently be used by the payment network 106 in connection with clearing and settling the deposit transaction (in a conventional manner). The entry may identify, for example, the amount of the funds 114 appended to the consumer's deposit account as a credit (as well as the PAN for the consumer's deposit account), and from where the funds 114 are to be collected (i.e., as a debit from an account of the merchant 102). In addition, the entry may identify any fees implemented in connection with the deposit transaction.

The deposit engine 118 also generates a confirmation reply, at 320, regarding the deposit transaction. In general, the confirmation reply indicates that the deposit transaction was successful (or approved), or not, and if approved, that the funds 114 have been deposited into the consumer's deposit account. In addition, the confirmation reply may include an indication of the amount of the funds 114 deposited into the consumer's deposit account (e.g., the full amount of the funds 114, any fees, etc.), a balance for the consumer's deposit account following the deposit, a date/time of the transaction, and a merchant location of the transaction. Further, and as with the request 116, the confirmation reply may include an ISO 8583 message, comprising various details associated with the deposit transaction and confirmation thereof (as described above, as well as other data). Then, at 322, the confirmation reply is transmitted to the merchant 102, for example, to the POS device associated with the merchant 102 along path A in the system 100, etc. It should be appreciated that, when a token is provided to the merchant 102 at 304, for initially identifying the consumer's deposit account to the merchant 102, the payment network 106 (or, in some embodiments, a third party token vault associated with the payment network 106) may translate the PAN, as (or if) included in the confirmation reply, back to the token when the confirmation reply is transmitted to the merchant 102 (e.g., the payment network 106 may likewise translate the PAN to the token as the confirmation reply passes through the payment network 106 on its way to the merchant 102 (e.g., along path A in the system 100, etc.), etc.).

As described above, the “payment-to” (or deposit) transactions herein are intended to provide near real-time access to the deposited funds. In connection therewith, the transactions will typically use PIN networks (e.g., as provided by Maestro, Pulse, Interlink, etc.). As such, typically there is no batch functionality as it relates to the transaction processing during the authorization. However, in instances were signatures are used, the acquirer 104 may generate (as indicated by the dotted lines in FIG. 3) an entry in a batch file (associated with the payment network 106) for the deposit transaction, at 324. When generated, the entry provides, from a standpoint of the acquirer 104, a record of where the funds 114 and any associated fees are coming from and where they are going. The batch file, and particularly the generated entry, can then subsequently be used by the payment network 106 in connection with clearing and settling the deposit transaction (in a conventional manner). The entry may identify, for example, the amount of the funds 114 received by the merchant 102 for deposit into the consumer's deposit account, as well as the PAN for the consumer's deposit account (indicating where the funds are to be routed). In addition, the entry may identify any fees implemented in connection with the deposit transaction.

Then in the method 300, upon receipt of the confirmation reply from the deposit engine 118, at 326, the merchant generates a deposit receipt for the consumer 112, which the consumer 112 then receives, at 328. The deposit receipt may indicate whether or not the deposit transaction was approved and/or successful, and may further indicate an amount of the funds 114 deposited into the consumer's deposit account, a balance of the deposit account following the deposit, and a listing of any fees associated with the deposit transaction. For example, the deposit receipt may include a printed receipt from the merchant 102 (e.g., printed from the POS device at the merchant 102, etc.). Or, the deposit receipt may include an electronic receipt transmitted to the consumer 112 as desired (e.g., via email, via SMS, etc.).

The method 300 is described herein in connection with the deposit engine 118 operating generally at (or in conjunction with) the issuer 108, to identify deposit request and append the funds 114 to the consumer's deposit account. However, it should be appreciated that the deposit engine 118 could alternatively perform similar operations (or functions) as a stand-alone entity (e.g., independent of the issuer 108, etc.) or generally at (or in conjunction with) the payment network 106, or other part (or combination of parts) of the system 100.

With that said, through the systems and methods herein, consumers can use merchants (and their associations with issuers via payment networks) to deposit funds at the issuers, instead of directly seeking out locations of the issuers to make such deposits. As can be appreciated, through the systems and methods herein, numerous additional locations may be available to the consumers to deposit funds into their desired deposit accounts (as provided by the issuers).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a deposit request from a merchant via a payment network and/or an acquirer, the deposit request including a request to deposit funds to a deposit account associated with the consumer where the funds to be deposited are received by the merchant from the consumer; (b) causing a balance of the deposit account to be increased by an amount associated with the funds, whereby the consumer is able to deposit the funds to the deposit account by presenting the funds to the merchant without directly interacting with a banking institution and/or automated teller machine (ATM) associated with the debit account; (c) causing a reply to be directed to a point of sale (POS) terminal at the merchant, the reply confirming approval of the deposit of the funds to the deposit account and/or indicating the balance of the deposit account after the deposit; (d) enrolling the deposit account to receive deposits from the merchant and/or enrolling the merchant to cause deposits to the deposit account; (e) approving the deposit request when a primary account number (PAN) associated with the deposit account is within a predefined range of PANs; and (f) declining the deposit request when the PAN associated with the deposit account is outside the predefined range of PANs.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in depositing funds to a deposit account associated with a consumer, the method comprising:
receiving, at a computing device, a deposit request from a merchant via a payment network and/or an acquirer, the deposit request including a request to deposit funds to a deposit account associated with the consumer where the funds to be deposited are received by the merchant from the consumer; and
causing, by the computing device, a balance of the deposit account to be increased by an amount associated with the funds, whereby the consumer is able to deposit the funds to the deposit account by presenting the funds to the merchant without directly interacting with a banking institution and/or automated teller machine (ATM) associated with the deposit account.

2. The computer-implemented method of claim 1, wherein the deposit request includes at least one of a 0100 message and a 0200 message consistent with an ISO 8583 standard associated with the payment network; and
wherein causing a balance of the deposit account to be increased includes causing the balance to be increased when at least one of the 0100 message and the 0200 message associated with the deposit request includes an indicator for the deposit of the funds to the deposit account.

3. The computer-implemented method of claim 1, wherein the deposit request includes a message consistent with an ISO 8583 standard; and
wherein causing a balance of the deposit account to be increased includes causing the balance to be increased when a data entry of the message includes an indicator for the deposit of the funds to the deposit account.

4. The computer-implemented method of claim 1, further comprising causing, by the computing device, a reply to be directed to a point of sale (POS) terminal at the merchant, the reply confirming approval of the deposit of the funds to the deposit account and/or indicating the balance of the deposit account after the deposit.

5. The computer-implemented method of claim 4, wherein receiving a deposit request from a merchant via a payment network and/or an acquirer includes receiving the deposit request as originating from the POS terminal at the merchant.

6. The computer-implemented method of claim 4, wherein causing a balance of the deposit account to be increased includes causing delivery of the funds, or at least a portion of the funds, to the deposit account from an account associated with the merchant.

7. The computer-implemented method of claim 1, wherein the funds received from the consumer, by the merchant, include cash; and
wherein causing a balance of the deposit account to be increased by an amount associated with the funds includes causing the balance to be increased by an amount equal to the cash received, by the merchant, from the consumer.

8. The computer-implemented method of claim 1, further comprising:
enrolling, by the computing device, the deposit account to receive deposits from the merchant and/or enrolling the merchant to cause deposits to the deposit account; and
identifying, by the computing device, the deposit account as enrolled to receive deposits from the merchant and/or that the merchant is enrolled to cause deposits to the deposit account.

9. The computer-implemented method of claim 8, further comprising:
approving, by the computing device, the deposit request when a primary account number (PAN) associated with the deposit account is within a predefined range of PANs; and
declining, by the computing device, the deposit request when the PAN associated with the deposit account is outside the predefined range of PANs.

10. The computer-implemented method of claim 1, further comprising generating, by the computing device, an entry for the deposit of the funds to the deposit account in a batch file to be submitted to the payment network in association with clearing and/or settlement of the deposit.

11. The computer-implemented method of claim 1, wherein causing a balance of the deposit account to be increased by an amount associated with the funds includes causing the balance of the deposit account to be increased in near real-time; and
wherein the deposit request involves use of a personal identification number (PIN), by the consumer, to verify the deposit account.

12. A non-transitory computer readable storage media including executable instructions for depositing funds to a primary deposit account, which when executed by at least one processor, cause the at least one processor to:
identify a message received from a merchant, via a payment network, as involving a deposit transaction to a primary deposit account, the message including an amount of funds received by the merchant from a consumer and a primary account number (PAN) received by the merchant from the consumer via an access device for the primary deposit account;
cause the amount of the funds, included in the message, to be appended to the primary deposit account, whereby the amount of the funds is appended to the primary deposit account based on presentation of the funds to the merchant rather than to a banking institution or an automated teller machine (ATM); and
generate and transmit a reply to the merchant, via the payment network, confirming that the amount of the funds, received by the merchant from the consumer, have been appended to the primary deposit account.

13. The non-transitory computer readable storage media of claim 12, wherein the executable instructions, when executed by the at least one processor in connection with identifying the message as involving a deposit transaction, cause the at least one processor to recognize a payment-to indicator in transaction code 28 of the message.

14. The non-transitory computer readable storage media of claim 12, wherein the executable instructions, when executed by the at least one processor, further cause the at least one processor to generate at least one entry for the deposit transaction in a batch file to be submitted to the payment network in association with clearing and/or settlement of the deposit transaction; and
wherein the at least one entry for the deposit transaction in the batch file includes at least a debit from an account associated with the merchant for the amount associated with the funds received from the consumer, and a credit to the primary deposit account for the amount associated with the funds.

15. The non-transitory computer readable storage media of claim 12, wherein the amount of the funds caused to be appended to the deposit account is equal to the amount of the funds received by the merchant from the consumer, whereby at least one fee associated with the deposit transaction for the funds is applied in addition to the amount of the funds received, by the merchant, from the consumer.

16. The non-transitory computer readable storage media of claim 12, wherein the executable instructions, when executed by the at least one processor in connection with causing the amount of the funds to be appended to the primary deposit account, cause the amount of the funds to be appended to the primary deposit account in near real-time; and
wherein the message received from the merchant includes use of a personal identification number (PIN), by the consumer, to verify the PAN for the primary deposit account.

17. A system for use in depositing funds to a deposit account associated with a consumer, the system comprising an issuer computing device configured to:
identify an ISO 8583 message received from a merchant, via a payment network, as involving a payment-to transaction to a primary deposit account, based on funds received by the merchant from a consumer and based on a primary account number (PAN) received by the merchant from the consumer via an access device for the primary deposit account; and
cause the funds to be transferred from an account associated with the merchant to the primary deposit account, such that a balance of the primary deposit account is increased by an amount associated with the funds, whereby the consumer is able to deposit the funds to the deposit account by presenting the funds to the merchant without directly interacting with a banking institution and/or automated teller machine (ATM) associated with the deposit account.

18. The system of claim 17, wherein the issuer computing device comprises:
a memory including a predefined range of account numbers associated with payment-to transactions; and
a processor in communication with the memory and configured to:
compare the PAN for the primary deposit account identified in the ISO 8583 message to the predefined range of account numbers stored in the memory;
when the PAN is within the predefined range of account numbers, cause the funds to be transferred from the account associated with the merchant to the primary deposit account; and
when the PAN is outside the predefined range of account numbers, decline to cause the funds to be transferred from the account associated with the merchant to the primary deposit account.

19. The system of claim 17, wherein the issuer computing device is configured to identify an ISO 8583 message received from a merchant, via a payment network, as involving a payment-to transaction to a primary deposit account, when a data element of the ISO 8583 message includes an indicator of the payment-to transaction.

20. The system of claim 17, wherein the issuer computing device comprises:
a memory including at least one batch file associated with a payment network; and
a processor in communication with the memory and configured to generate an entry in said at least one batch file indicative of the funds transferred to the primary deposit account.
